(19) United States
(12) Patent Application Publication
(10) Pub. No.: US 2011/0178734 A1
(43) Pub. Date: Jul. 21, 2011

(54) METHOD AND APPARATUS FOR DETERMINING THE FLOW RATE OF A FLUID

(75) Inventors: Thomas Clerico, Gradignan (FR); Matthieu Guirardel, Bordeaux (FR)

(73) Assignee: RHODIA OPERATIONS

(21) Appl. No.: 12/992,641

(22) PCT Filed: May 15, 2009
(86) PCT No.: PCT/FR09/50910

§ 371 Date: Jan. 27, 2011

(30) Foreign Application Priority Data
May 16, 2008 (FR) .08 53175

(51) Int. Cl. G01F 3/02; G06F 19/00

(52) U.S. Cl. 702/45; 73/232

(57) ABSTRACT

A procedure for determining the flow rate of a fluid includes introducing a fluid into a flow member (6) in the form of a series of plugs (20) separated by segments (22) of a carrier phase, measuring the rate of movement of the plugs in the flow member, and determining therefrom the flow rate of the fluid (20, 22).

The present invention relates to a method for determining the flow rate of a fluid, and to an installation for implementing this method.

The determination method according to the invention makes it possible to access numerous types of information, relating to the flow of liquids or gases. As nonlimiting examples, this determination method can be used to deduce information relating to the transport of a solvent through the walls of a chamber, or even information relating to the expansion of this chamber.

The invention sets out in particular to study the permeability of vessels in which hydrocarbons are stored. In this respect, it should be stressed that the storage and transport of these hydrocarbons pose problems, which are specifically linked to the permeability of the thermoplastic polymers used to manufacture storage and transport structures.

In the particular case of petrol tanks for motor vehicles, the quantity of hydrocarbon vapor emitted outward, because of the permeability of the walls of the tanks, is subject to increasingly stringent standards. In these conditions, this permeability must be measured as accurately as possible, based on the volume variation of the hydrocarbon initially stored.

To this end, it is first of all known to implement gravimetric-type measurements. The fluid for which the volume variation is to be known is first of all stored in its receiving chamber. Then, the weight loss of the assembly formed by the container and its content is monitored as a function of time. Given that the weight of the container is assumed to be constant, the weight variation of the fluid is determined, which makes it possible to deduce the fraction of fluid that has evaporated out of the vessel.

Alternatively, it is also known to carry out so-called emission measurements. Fluid is sent into a polymer tube, for which the permeability characteristics are to be tested. The assembly is then placed in a sealed volume, making it possible to recover the vapors that have passed through the walls of the tube. These vapors are then directed to a cell, containing active carbon which absorbs certain components. By monitoring the trend of the weight of these active carbons, it is then possible to deduce the permeability value of the tube.

These various known methods do, however, include certain drawbacks. In practice, they offer a relatively low sensitivity. Furthermore, they are not likely to reflect, satisfactorily, the reality of the physico-chemical phenomena being studied.

That said, the invention aims to remedy these various drawbacks. To this end, its subject is a method for determining at least one flow rate value for at least one fluid, in which this fluid, called flow fluid, is fed into a flow member in the form of a succession of plugs separated by segments of a carrier phase, the rate of movement of these plugs in the flow member is measured, and the or each flow rate value of this flow fluid is deduced therefrom.

According to other features of the invention:
the flow member is made to communicate with the internal volume of a chamber;
a solvent is fed into at least a part of the internal volume of the chamber, and information relating to the transport of this solvent through at least a part of the walls of the chamber is deduced from the flow rate value of the flow fluid;
a chamber is used that comprises a body, through which the solvent is not transported, and an insert that can be added, notably removably, to this body, this insert being made of a material through which the solvent can be transported, this material being notably permeable to the solvent;
the chamber is set to a temperature and a pressure that are substantially constant;
a variation in the volume of the flow fluid as a function of time is deduced from the flow rate;
a transitional region is identified that corresponds to the transfer of material from the solvent to the interior of the walls of said part of the chamber;
a permanent region is identified that corresponds to the actual permeability of these walls facing the solvent;
the solvent is separated from the flow fluid by means of a damping fluid;
the solvent is formed by a mixture of components and at least one analysis of the gaseous fraction, originating from the transport of this solvent through said part of the walls of the chamber, is carried out;
information relating to the expansion of the chamber is deduced from said flow rate value;
a chamber is used that is not permeable to the fluid, and at least one operating condition is varied, notably the temperature and/or the pressure;
the rate of movement of the plugs is measured by means of a digital photographic system, in particular a camera;
a number of flow members are used that extend at least partially parallel to one another, various flow fluids are fed into these various flow members, and the rate of movement of the plugs of each flow fluid is measured by means of a single photographic system;
the flow rate value is deduced by using the equation:

Q=V·S·F; in which
Q corresponds to the fluid flow rate;
V corresponds to the variation of pixels per time unit, associated with the photographic system;
S corresponds to the internal section of the flow member; and
F corresponds to the enlargement of the photographic system;
the internal section of the flow member is between 10⁻⁴ mm² and 1 mm², preferably between 10⁻³ and 10⁻¹ mm².

Another subject of the invention is an installation for implementing the above method, comprising:
at least one chamber;
at least one flow member, made to communicate with an inlet of a corresponding chamber;
at least one photographic system, specifically for viewing the movement of plugs inside a corresponding flow member; and
computer processing means for the images obtained by the or each photographic system.

According to other features of the invention:
the or each flow member is filled by means of a succession of plugs, separated by carrier phase segments;
the flow member is formed by an insulated tube;
the flow member is formed by a channel etched into a wafer.

The invention will be described below, with reference to the appended drawings, given solely as nonlimiting examples, in which:

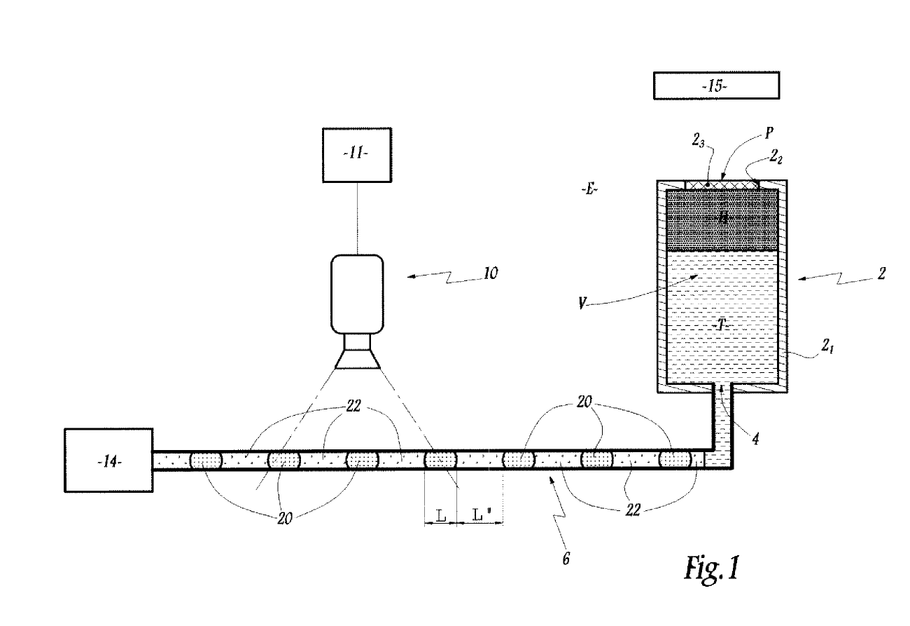

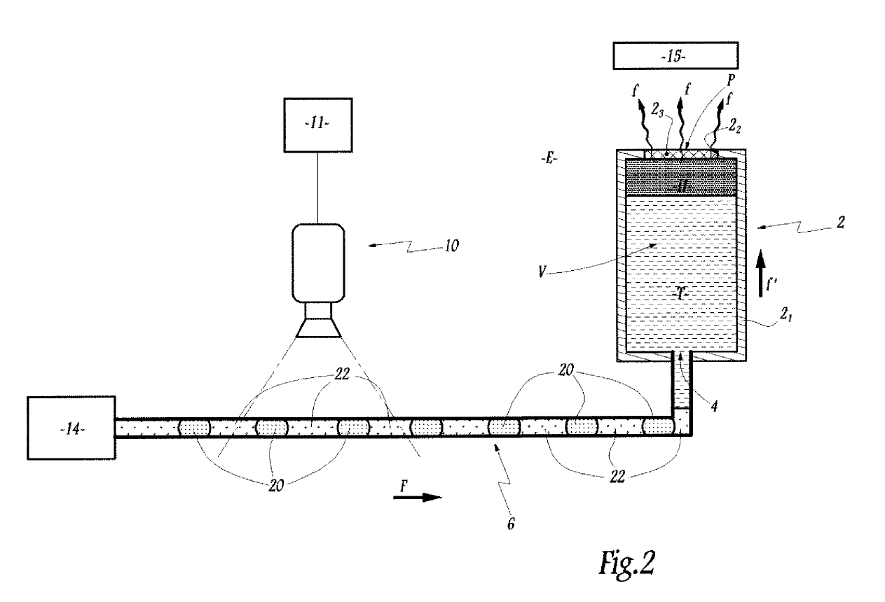

FIGS. 1 and 2 are front views, diagrammatically illustrating two successive steps in implementing a method for determining the flow rate of a fluid, in accordance with the invention;

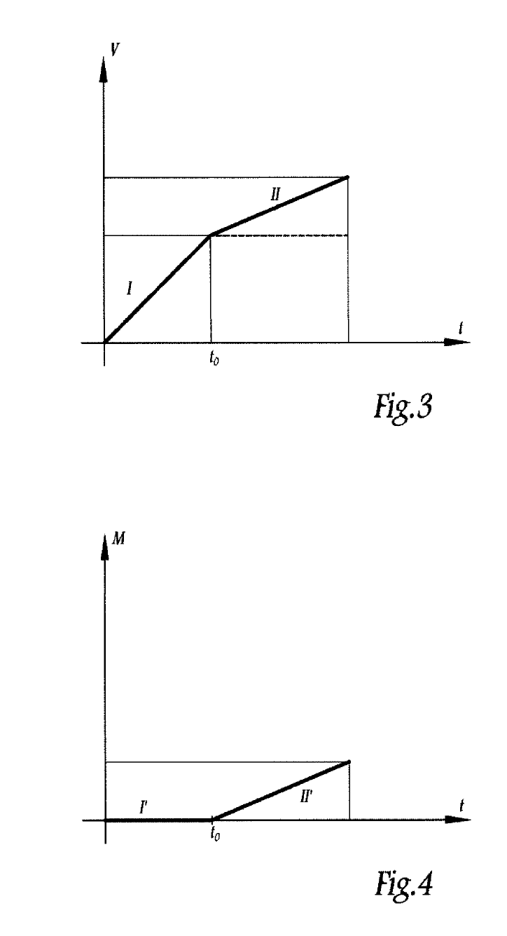

FIG. 3 is a graph, illustrating the volume variation of a fluid as a function of time, determined in accordance with the invention;

FIG. 4 is a graph, similar to FIG. 3, illustrating the implementation of the prior art; and

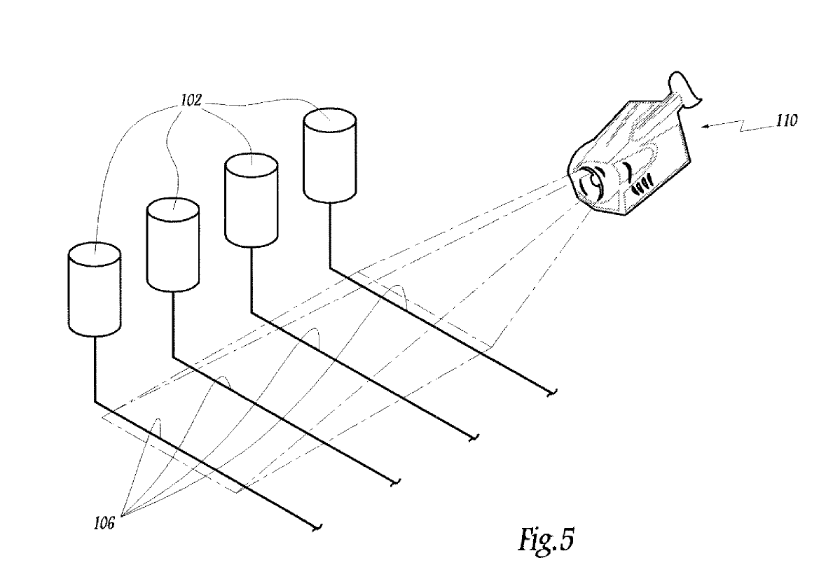

FIG. 5 is a perspective view, illustrating a variant embodiment of an installation according to the invention.

As shown in FIG. 1, the installation for determining a fluid flow rate, according to the invention, comprises a flow member 6, for example made in the form of a flexible tube, notably made of PTFE. This tube 6 is advantageously translucent, in particular transparent, in order to cooperate with a photographic system, which in this case is a camera 10. This camera, which is pointed at this flow tube 6, is associated with computer means 11, making it possible to process the data generated by this camera.

Advantageously, the internal section of the flow member 6 is between 10⁻⁴ mm² and 1 mm², preferably between 10⁻³ and 10⁻⁴ mm². This internal section refers to one dimension, which excludes the walls of the flow member 6.

Downstream, namely to the right in FIGS. 1 and 2, the flow member 6 opens into a chamber 2, which can be made in a single piece, or be formed by a number of different elements. In the example illustrated, the chamber 2 comprises a body 2₁, made of a non-permeable material such as a metal. This body 2₂ delimits a window for which the permeability, for example, is to be measured.

This embodiment is advantageous inasmuch as a single body 2₁ can be used, then a number of successive inserts can be added, which are made of the different materials that are to be tested. V denotes the internal volume of the chamber 2, P the walls of the insert 2₃, and E the outside ambient air. Finally, the seal-tightness between the inlet 4 of the chamber 2, and the tube 6, is ensured by any appropriate means.

Also provided is a pressure regulation member, intended to compensate for the head losses inside the tube 6 and the chamber 2. This member 14, which is of a type that is known per se, is placed upstream of the tube 6. Finally, an analysis apparatus 15 is provided, positioned close to the insert 2₃. This appliance 15, which is, for example, a gaseous phase chromatograph, can be used to analyze the gaseous phase escaping from the chamber 2, as will be seen in more detail hereinbelow.

The implementation of the method according to the invention, by means of the installation described hereinabove, will now be explained.

In the present example, it is assumed that the permeability of the walls P of the insert 2₃ to a fluid which is, for example, a hydrocarbon H, is to be determined. For this, first of all, at least a part of the internal volume V of the chamber is filled using this hydrocarbon. In the example illustrated, this hydrocarbon is fed only into the top part of the chamber, namely in the vicinity of the insert 2₃.

Furthermore, the internal part of this chamber is occupied by a damping fluid T, so that all the internal volume of the chamber is occupied by fluid. It will also be noted that the use of the damping fluid T is advantageous, inasmuch as the latter makes it possible to avoid, on the one hand, hydrocarbon leaks toward the tube 6 and, on the other hand, mixing between the hydrocarbon being studied and the fluid flowing in the tube 6, as will be seen hereinbelow.

A series of plugs 20 are then formed, in a manner known per se, in the carrier phase segments 22. Within the meaning of the invention, plugs are fluid phases, or even solids, flowing along the tube 6, occupying substantially the width of the latter. These plugs are separated from one another by a carrier fluid, which is not miscible with the fluid forming the plugs.

These plugs can be formed, in a manner known per se, in conventional structure generation means, which are distinct from the tube 6. Then, when these plugs are formed, they are injected into the tube 6, by any appropriate means. As a variant, these plugs may be formed directly in the tube 6, by any appropriate conventional procedure.

The tube 6 then contains an alternating succession of plugs and carrier phase segments, which can be likened to a continuous string of plugs. These plugs 20 and these segments 22 form a flow fluid, within the meaning of the invention, for which the flow rate inside the tube is to be determined, according to the steps that will be described hereinbelow.

Within the string described above, plugs of the same kind or of different kinds can be used. As an example, these plugs are, for example, drops formed by a mixture of colored water and glycerol, whereas the carrier phase is, for example, formed by a silicone oil.

Advantageously, the distinction between these drops and these carrier phase segments is made by the camera 10, notably by contrast. Thus, the drops or the carrier phase may be dark, whereas the carrier phase or the drops may be light, so that the respective volumes of the drops and of the segments can be seen. It is also possible to provide for the drops and the segments to be transparent, but with their interface remaining visible to the camera.

L denotes the length of the various drops, and L′ the length of the various intermediate segments. Advantageously, these lengths L and L′ are less than the value of the field of the camera, notably less than 5 cm, typically between 0.1 and 1 mm. It will also be noted that, in the example illustrated, the various drops have the same length L, whereas the various segments have the same length L′. However, it is possible to provide for the drops and/or the segments to have differing lengths.

It is assumed that the operating conditions are such that the chamber 2 does not expand and that the density of the hydrocarbon is constant. It is also assumed that a fraction of the hydrocarbon leaves the internal volume V of the chamber, in which it was initially stored, to penetrate into the walls P, or even to the outside E.

In these conditions, because of the presence of the pressure regulation member 14, the output of this hydrocarbon fraction H, represented by the arrows f, causes the damping fluid T to rise in the chamber 2, represented by the arrow f′, and a movement of the string of plugs 20 according to the arrow F. These various fluid flows are illustrated in FIG. 2, with the value of the movements discussed above being exaggerated, in the interests of clarity.

It will be noted that the use of the damping fluid T makes it possible to avoid having the plugs 20 penetrate into the internal volume V, when this damping fluid occupies a part of the tube 6, as is illustrated in this FIG. 2. This is advantageous, inasmuch as these plugs can then be reused easily, for a subsequent procedure.

According to the invention, the rate of movement of the plugs 20 inside the tube 6 is measured using the camera associated with the computer processing means 11. Given that the section of this tube is also known, it is possible to deduce therefrom the volume of flow fluid, formed by the plugs 20 and the segments 22, moved per time unit inside this tube. This value corresponds to the hydrocarbon volume variation inside the chamber 2.

More specifically, the following equation is used:

Q=V·S·F, in which
Q corresponds to the volume variation per time unit (in mm³/s)
V corresponds to the movement of the plugs in pixels per time unit, measured by the camera (in pixel/s)
S corresponds to the internal section of the channel (in mm²) and
F is the enlargement of the camera (in mm/pixel), namely the correlation between the number of pixels and the distance.

In this first phase, instantaneous flow rate values were determined. In a later phase, it is also possible to calculate the integral of this variation, which makes it possible to obtain a curve illustrating the variation in the volume, as a function of time.

FIG. 3 illustrates the variation, as a function of time t, in the volume V of the flow fluid, formed by the plugs 20 and the segments 22, which has moved in the tube 6 in order to compensate for the output of hydrocarbon H. It will be noted that these curves break down firstly into a first transitional-type region, denoted I, having a relatively steep slope, and a second permanent-type region II, with a shallower slope.

The region I corresponds to the initial phase of hydrocarbon escape, out of the internal volume V, namely that for which this hydrocarbon diffuses and stabilizes within the thickness of the walls P of the insert 2₃. This region I is representative of the progress of the hydrocarbon propagation front inside the walls P.

Then, the region II relates to a later phase, during which the hydrocarbon migrates toward the outside E. This region II corresponds to a permanent regime, for which the diffusion and the solubility of the hydrocarbon are balanced, which thus defines the permeability of the material to hydrocarbon.

This FIG. 3 therefore makes it possible to access information relating to the transport of the hydrocarbon, through the insert 2₃. This generic term “transport” comprises, on the one hand, the transfer of this hydrocarbon toward the interior of the walls, represented by the region I, and, on the other hand, the actual permeability of these walls to hydrocarbon, which is represented by the region II.

In this respect, it will be noted that the curve of FIG. 3 may show a region II that is substantially horizontal, as illustrated by a broken line. This means that, in this case, there is only transfer of the hydrocarbon to the walls P. On the other hand, this hydrocarbon is not diffused toward the ambient air.

As a variant, provision can be made for the solvent being studied to be formed by a mixture of different components. In this case, the appliance 15 is used to perform at least one analysis of the gaseous fraction evacuated out of the chamber 2, via the insert 2₃. Advantageously, such an analysis can be used to identify whether one or other of the components of this solvent has a tendency to escape before or after the other component or components.

FIG. 3 highlights an advantage of the invention, namely the fact that it makes it possible to access more information than in the prior art. In this respect, FIG. 4 illustrates a curve, obtained by applying gravimetric measurements in accordance with the state of the art. It will be recalled that this method makes it possible to study only the weight loss of the whole, formed by the container and the content.

In these conditions, this FIG. 4 illustrates the variation as a function of time, not of the volume V as in the case of the invention, but of the weight M. The corresponding curve includes a region I′, which coincides with the x axis, then a region II′, with the same slope as that II of FIG. 3. It will also be noted that the transition between, on the one hand, the regions I and II and, on the other hand, the regions I′ and II′, occurs on either side of a transition time, denoted t₀. As can be clearly seen in FIG. 4, the phase of diffusion of the hydrocarbon in the thickness of the insert 2₃ is not identified in the prior art, since this phenomenon does not induce any weight loss of the whole formed by the container and the content.

It will also be noted that it is possible to implement a method for screening different materials, based on the installation of FIGS. 1 and 2. To this end, after having identified the permeability properties of the material forming the first insert 2₃, according to the above steps, it is replaced with another insert, made of a different material, for which the properties are to be identified. It is then possible to test a large number of materials, in a convenient manner, by successively placing different inserts in the window 2₂. At the end of this screening phase, one or more preferred materials are identified as having interesting permeability properties.

The invention is not limited to the examples described and represented.

Thus, provision can be made for the flow member to be made, not in the form of an insulated tube, but in the form of a channel provided in a wafer. This channel is then produced according to the conventional procedures of the prior art, which are notably described in “D. C. Duffy, J C MacDonald, Olivier J. A. Schueller, Gorges M. Whitesides, Anal. Chem., 70, p. 4974-4984, 1998”. The downstream end of the channel then opens out at the inlet of the chamber 2, via any appropriate means.

In the example illustrated, a flow rate is measured that is linked to the output of a fluid, outside of the internal volume of the chamber. It is also possible to measure, in accordance with the invention, a flow rate linked to an arrival of fluid in this internal volume. In this case, this phenomenon induces a movement of the plugs 20 and of the segments 22, not to the right as in FIG. 2, but to the left. Similarly, the rate of displacement of the plugs is measured, which makes it possible to access information relating to the increase in the volume of fluid in the chamber.

In the preceding text, a fluid flow rate was measured, in order to deduce therefrom information relating to the permeability of the chamber. However, it is also possible to implement the method according to the invention, in order to access information relating to the expansion of the chamber.

In this case, the operating conditions are varied, in particular the temperature and/or the pressure and/or the humidity, so as to obtain a modification of the value of the internal volume of the chamber. Assuming that the fluid initially admitted into this chamber has a constant density, the expansion of the chamber results in an arrival of plugs 20 toward its internal volume, since the volume of the fluid is constant. Measuring the flow rate of these plugs, which are thus made to move, makes it possible to access the corresponding value of expansion of the chamber.

Finally, in the example illustrated above, the camera 10 is associated with a single flow tube 6. However, it is also possible to provide for one and the same camera 110 to be able to view the movement of plugs inside a number of flow tubes 106, which are in turn in communication with a number of chambers 102, as is illustrated in FIG. 5. In other words, a single camera can be used to simultaneously implement a number of volume variation measurements.

The invention makes it possible to achieve the objectives mentioned previously.

In practice, the invention makes it possible to determine, in a simple and cost-effect manner, the volume variation of a fluid. Furthermore, this implementation can be done automatically, and continuously.

Furthermore, the method according to the invention is highly sensitive, because the use of a flow member of small section makes it possible to detect very low flow rate values, which may be less than one nanoliter per hour. Finally, as illustrated in FIG. 3, the invention makes it possible to access a large quantity of information, in particular relating to the transient escape phase of a fluid escaping out of a chamber.

Hereinbelow, an exemplary implementation of the invention is described purely as an indication.

A chamber 2 is used, whose body 2₁ is made of stainless steel. The window 2₂ of this chamber 2 is blocked by means of an insert 2₃, made of polyamide. The internal volume of the chamber 2 is 2 ml. This chamber is completely filled, apart from the coupling regions, using an alcohol, to which the polyamide is permeable.

This chamber is coupled to a flow tube 6, made of PFA. This tube has a length of 2 meters, and an internal diameter of 250 microns. It is associated with an electropneumatic pressure regulator 14, which conforms to that marketed by the company SMC under the reference ITV0010.

Drops are generated that are formed by a mixture of water, glycerol and a colorant, which are separated by a succession of carrier phase segments formed by a silicone oil. The respective lengths L and L′, of each drop and of each segment, are approximately 0.5 mm.

A SONY XACD 70 camera 10 is also used, pointed at a rectilinear segment of the tube 6. The volume variation of the fluid inside the chamber is then measured, while maintaining the operating conditions at a temperature of 40° C. and a pressure of 300 mbar.

By using the method described above, the regions I and II of FIG. 2 are accessed. It can be seen that, after 1 hour, 0.2 ml of fluid has diffused, from the internal volume toward the walls of the chamber. Then, after this initial phase, this fluid migrates toward the outside, which corresponds to the region II of FIG. 2. After 24 hours, the total measured volume variation is 1 ml.

1.-20. (canceled)

21. A method for determining at least one flow rate value for at least one fluid, wherein such fluid, deemed the flow fluid, is introduced into a flow member in the form of a succession of plugs separated by segments of a carrier phase, wherein the rate of movement of these plugs in the flow member is measured, and wherein said at least one flow rate value of this flow fluid is determined therefrom.

22. The method as defined by claim 21, wherein said flow member communicates with the internal volume of a chamber.

23. The method as defined by claim 22, wherein a solvent is introduced into at least a part of the internal volume of the chamber, and wherein information relating to the transport of this solvent through at least a part of the walls of the chamber is determined from the flow rate value of the flow fluid.

24. The method as defined by claim 23, wherein the chamber comprises a body, through which the solvent is not transported, and an insert removably set therein, such insert being made of a material through which the solvent can be transported.

25. The method as defined by claim 23, wherein the chamber is at a temperature and a pressure that are substantially constant.

26. The method as defined by claim 23, wherein a variation in the volume of the flow fluid as a function of time is determined from the flow rate.

27. The method as defined by claim 26, wherein a transitional region is identified that corresponds to the transfer of material from the solvent to the interior of the walls of said part of the chamber.

28. The method as defined by claim 26, wherein a permanent region is identified that corresponds to the actual permeability of these walls facing the solvent.

29. The method as defined by claim 23, wherein the solvent is separated from the flow fluid by means of a damping fluid.

30. The method as defined by claim 23, wherein the solvent comprises a mixture of components and at least one analysis of a gaseous fraction, originating from the transport of this solvent through said part of the walls of the chamber, is carried out.

31. The method as defined by claim 22, wherein information relating to expansion within the volume of the chamber is determined from said flow rate value.

32. The method as defined by claim 31, wherein the useful volume of the chamber is not permeable to the fluid, and wherein at least one operating condition is varied, optionally the temperature and/or the pressure.

33. The method as defined by claim 21, wherein the rate of movement of the plugs is measured by means of a digital photographic system.

34. The method as defined by claim 33, wherein a number of flow members are employed that extend at least partially parallel to one another, various flow fluids are introduced into these various flow members, and wherein the rate of movement of the plugs of each flow fluid is measured by means of a single photographic system.

35. The method as defined by claim 33, wherein the flow rate value is determined from the equation:
Q=V·S·F; in which
Q corresponds to the fluid flow rate;
V corresponds to the variation of pixels per time unit, associated with the photographic system;
S corresponds to the internal section of the flow member; and
F corresponds to the enlargement of the photographic system.

36. The method as defined by claim 21, wherein the internal section of the flow member ranges from 10⁻⁴ mm² to 1 mm².

37. Apparatus for conducting the method as defined by claim 22, comprising:
at least one chamber;
at least one flow member, communicating with an inlet of a corresponding chamber;
at least one photographic system for viewing the movement of plugs inside a corresponding flow member; and
computer processing means for the images obtained by the or each photographic system.

38. The apparatus as defined by claim 37, wherein said at least one flow member is filled by means of a succession of plugs, separated by carrier phase segments.

39. The apparatus as defined by claim 37, wherein the flow member comprises an insulated tube.

40. The apparatus as defined by claim 37, wherein the flow member comprises a channel etched into a wafer.

41. The method as defined by claim 24, said material being permeable to said solvent.
